(19) United States
(12) Patent Application Publication
(10) Pub. No.: US 2008/0092195 A1
(43) Pub. Date: Apr. 17, 2008

(54) Digital broadcast receiver and broadcast data processing method

(75) Inventor: Dong Soo Lim, Gumi-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/827,271

(22) Filed: Jul. 11, 2007

(30) Foreign Application Priority Data
Oct. 12, 2006 (KR) 2006-0099186

(51) Int. Cl. H04N 7/173

(52) U.S. Cl. 725/131

(57) ABSTRACT

A digital broadcast receiver and broadcast data processing method includes: separating received digital broadcast data into audio data and video data; detecting an image frame of a specified type in the video data to decode the detected image frame into output video data; synchronizing the output video data with the audio data to be output, and outputting the output video and audio data in a synchronized manner. Decoding image frames of a selected type only can reduce the processing load and power consumption of a video decoding unit.

### CLAIMS OF PRIORITY

This application claims priority to an application entitled “DIGITAL BROADCAST RECEIVER AND BROADCAST DATA PROCESSING METHOD,” filed in the Korean Intellectual Property Office on Oct. 12, 2006 and assigned Serial No. 2006-0099186, the contents of which are incorporated herein by reference.

### BACKGROUND OF THE INVENTION

1. Field of the Invention

The present invention relates generally to a mobile terminal and, more particularly, to a digital broadcast receiver and broadcast data processing method for a mobile terminal.

2. Description of the Related Art

Digital broadcasting provides various digitally modulated signals including audios and videos to users. In particular, digital multimedia broadcasting (DMB) enables users in motion to receive various broadcast programs through portable or in-vehicle receivers equipped with an omnidirectional receiving antenna.

Advances in storage devices capable of storing vast amounts of digital data, such as moving pictures and music videos, and popularization of mobile terminals have enabled a rapid development and commercialization of mobile terminals having a DMB reception capability, for example DMB phones. While in motion, users can watch or listen to broadcast programs, such as short films or songs, through DMB phones.

However, a conventional mobile terminal having a digital broadcast reception capability decodes the received video data, which includes three types of image frames (I-frames, P-frames and B-frames), and displays the decoded video data on a display screen. For an audio-centric digital broadcast, such as a music program, in which video data is less important, decoding and displaying of whole video data may result in an unnecessary processing load on a digital broadcast receiving module of the mobile terminal. Thus, a video streaming service may be degraded, and the amount of power consumption may be increased.

### SUMMARY OF THE INVENTION

The present invention provides a digital broadcast receiver and a broadcast data processing method that extract image frames of a particular type only from a received digital broadcast for decoding.

One aspect of the present invention is to provide a digital broadcast receiver and broadcast data processing method that increases the speed of a streaming service.

Another aspect of the present invention is to provide a digital broadcast receiver and broadcast data processing method that reduce a processing load on and power consumption of a video decoding unit.

In accordance with an exemplary embodiment of the present invention, a broadcast data processing method includes: separating received digital broadcast data into audio data and video data; detecting, if a frame detection mode for a particular frame type is set, an image frame of the specified type in the video data to decode the detected image frame into an output video data; synchronizing the output video data with the audio data to be output, and outputting the output video and audio data in a synchronized manner.

In accordance with another exemplary embodiment of the present invention, a digital broadcast receiver includes: a broadcast receiving unit for receiving digital broadcast data; a data separating unit for separating received digital broadcast data into audio data and video data; an input unit for inputting frame type information from a user to set a frame detection mode; a video decoding unit for decoding an image frame, in the video data, of a type specified in the frame type information; a control unit for synchronizing output video data of the decoded image frame with the audio data to be output; and a display unit for displaying the output video data in a synchronized manner with the audio data to be output.

### BRIEF DESCRIPTION OF THE DRAWINGS

The above features and advantages of the present invention will be more apparent from the following detailed description in conjunction with the accompanying drawings, in which:

FIG. 1 illustrates a configuration of a digital multimedia broadcasting (DMB) system;

FIG. 2 illustrates a configuration of a digital broadcast receiver according to an exemplary embodiment of the present invention; and

FIG. 3 is a flow chart illustrating a digital broadcast data processing method according to another exemplary embodiment of the present invention.

### DETAILED DESCRIPTION OF THE INVENTION

Hereinafter, exemplary embodiments of the present invention are described in detail with reference to the accompanying drawings. The same reference symbols identify the same or corresponding elements in the drawings. For the purposes of clarity and simplicity, detailed descriptions of constructions or processes known in the art may be omitted to avoid obscuring the invention in unnecessary detail.

To assist the understanding of the present invention, a brief introduction to digital multimedia broadcasting (DMB) is provided. Although the present invention is applied to DMB, it should be noted that the teachings of the present invention may also be applied to any digital broadcasting, such as DMB, digital video broadcasting (DVB), and media forward link only (MediaFLO).

DMB services are based on digital audio broadcasting (DAB) technologies for digital radios and include multimedia broadcasting concepts to delivering moving images and information services such as weather, news and location services. DMB services can provide compact disc (CD) or digital versatile disc (DVD)-like high quality audio and video broadcast data to users in motion through mobile or in-vehicle receivers, and they are attracting attention as means for next generation broadcasting services.

That is, DMB services enable users in motion to receive various multimedia broadcast data on multiple channels through mobile or in-vehicle terminals having an omnidirectional receiving antenna.

Compared with the existing broadcasting services, DMB services can be mainly distinguished for its mobility. DMB systems are classified by signal transmission mechanisms into terrestrial and satellite systems. The following table summarizes a comparison between DMB systems and the existing broadcasting systems.

TABLE 1

| | Mobility | | Signal |
|---|---|---|---|
| | Fixed | Mobile | Transmission |
| Transmission | existing public | Terrestrial DMB | Ground station |
| mechanism | broadcasting | | |
| | existing satellite | Satellite DMB | Artificial |
| | broadcasting | | satellite |
| Size | Middle to large | Very small | |
| comparison | receiver | receiver | |

As shown in Table 1, compared with the existing broadcasting services, DMB services can be characterized by mobility and small size of receivers. Further, broadcasting services are provided though ground stations in terrestrial DMB systems and through artificial satellites in satellite DMB systems.

In a satellite DMB system as a new broadcast medium, programs are transmitted from a DMB broadcast center to a satellite, which then retransmits the programs to a plurality of mobile DMB terminals in a wide coverage area of the satellite. Satellite DMB services are available in outdoor environments across a large area. Gap fillers or repeaters may be required to receive DMB signals and retransmit the received DMB signals in order to provide services to users in shadow areas, such as underground or indoor regions.

In a terrestrial DMB system, programs are transmitted through a spectrum suitable for terrestrial propagation. Unlike the satellite DMB system, broadcast signals are transmitted through base stations, which are similar to those for mobile terminals, on the ground. A terrestrial DMB service is a multimedia service combining video, audio and data broadcasting provided through terrestrial waves to users in motion.

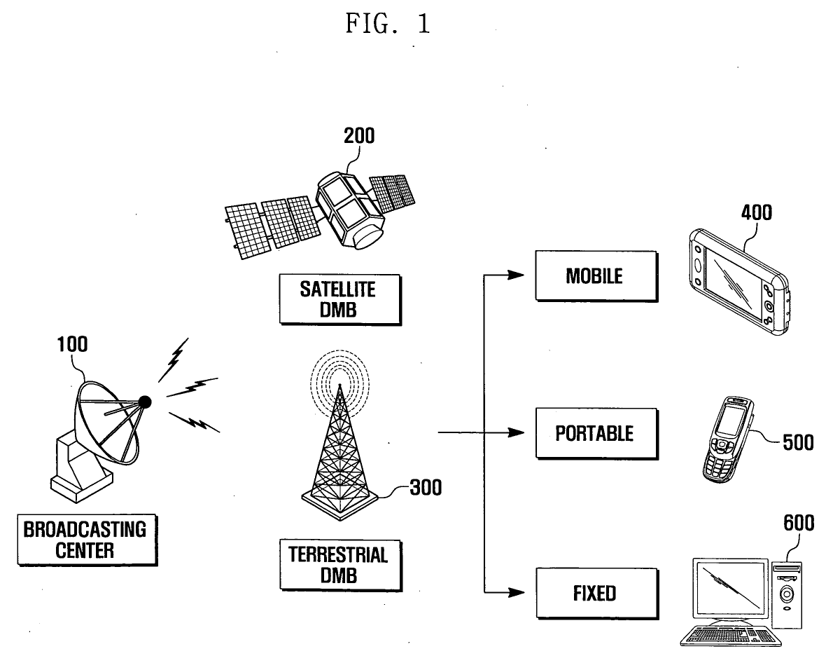

FIG. 1 illustrates a configuration of a DMB system.

Referring to FIG. 1, the DMB system includes a broadcasting center 100, one or more satellites 200, one or more base stations 300, and a plurality of mobile, portable and fixed receivers, such as vehicle receivers 400, mobile terminals 500 and home receivers 600.

The broadcasting center 100 compresses and modulates DMB signals representing audio, video and data signals, and transmits the modulated DMB signals to corresponding satellites 200 or base stations 300.

Each satellite 200 or base station 300 receiving the DMB signals from the broadcasting center 100 amplifies the received DMB signals, and retransmits the amplified DMB signals at different frequencies to the receivers 400, 500 and 600.

Each receiver 400, 500 or 600 receives the DMB signals from the corresponding satellite 200 or base station 300, and demodulates and decompresses the received DMB signals to output uncompressed audio, video, and data signals.

A rapid advance in digital broadcasting technologies have enabled users in fast motion to receive digital broadcast programs, which in turn created a demand for more convenient functions and services.

To address the newly needed services, the present invention provides an improved way of processing video data and mainly in application where audio data is more dominant than video data. According to the teachings of the present invention, only image frames of a selected type are extracted from video data of a received DMB music broadcast, and then decoded for enhancing the speed of a streaming service and for reducing the processing load on and power consumption of a video decoding unit.

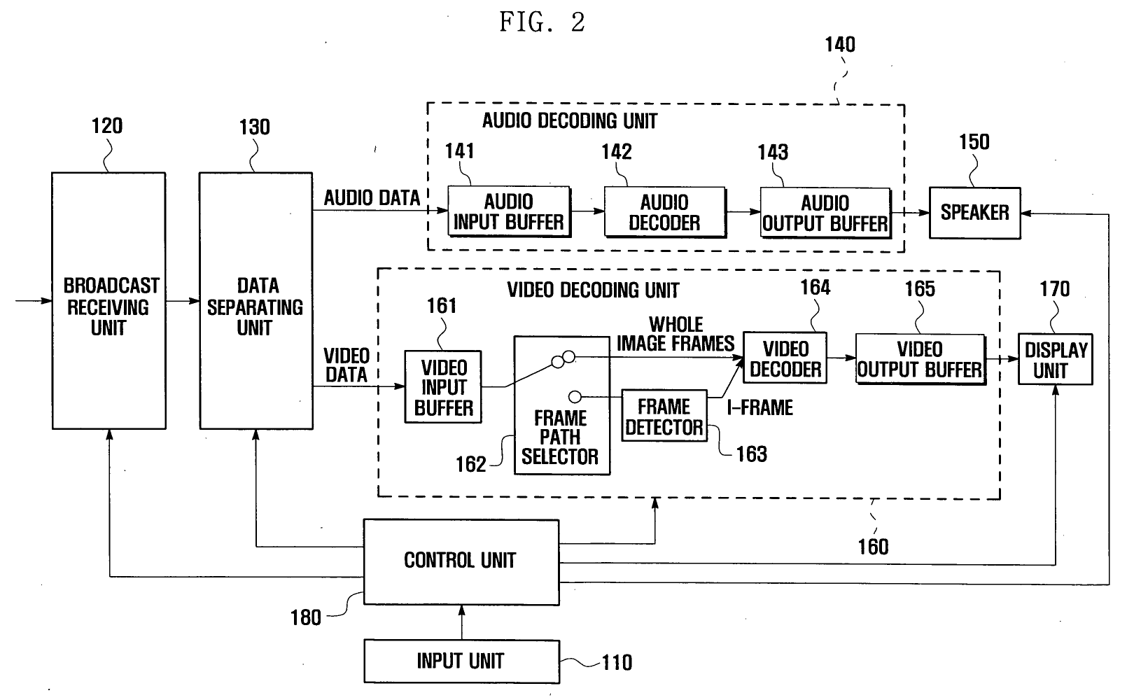

FIG. 2 illustrates a configuration of a digital broadcast receiver according to an exemplary embodiment of the present invention.

Referring to FIG. 2, the digital broadcast receiver includes an input unit 110, broadcast receiving unit 120, data separating unit 130, audio decoding unit 140, speaker 150, video decoding unit 160, display unit 170, and control unit 180.

The input unit 110 includes a touch screen or a key pad having a plurality of keys such as function keys, alphanumeric keys and special keys. The input unit 110 receives a command signal to control the operation of the digital broadcast receiver and sends the received command signal to the control unit 180. In particular, the input unit 110 receives a frame type command from the user for selection of a desired image frame type (for example, an I-frame) and send the corresponding frame type information to the control unit 180.

The broadcast receiving unit 120 receives a broadcast signal corresponding to a broadcast channel selected by the user, extracts digital broadcast data from the received broadcast signal through deinterleaving operations, and outputs the extracted digital broadcast data to the data separating unit 130.

The data separating unit 130 separates digital broadcast data from the broadcast receiving unit 120 into audio data and video data and sends the audio data to the audio decoding unit 140 and the video data to the video decoding unit 160.

The audio decoding unit 140 decodes audio data from the data separating unit 130 and includes an audio input buffer 141, audio decoder 142, and audio output buffer 143.

The speaker 150 reproduces decoded audio data from the audio output buffer 143 of the audio decoding unit 140.

The video decoding unit 160 decodes video data from the data separating unit 130 according to a video coding standard (for example, Moving Picture Experts Group (MPEG)). The video decoding unit 160 includes a video input buffer 161, frame path selector 162, frame detector 163, video decoder 164, and video output buffer 165.

An MPEG-coded video stream consists of successive group of pictures (GOP). A GOP is a unit of MPEG coding and decoding, and includes an intra-coded frame (I-frame), one or more predictive frames (P-frame), and one or more bidirectional frames (B-frame). A GOP begins with an I-frame, followed by several P-frames and several B-frames in order. With the next I-frame a new GOP begins. The number of image frames in a GOP is the size of the GOP.

The video input buffer 161 stores image frames in video data from the data separating unit 130 until a GOP is formed and sends the stored image frames forming a GOP to the video decoder 164.

The frame path selector 162 directs image frames stored in the video input buffer 161 to the frame detector 163 when a frame detection mode for a particular frame type is set, and directly to the video decoder 164, bypassing the frame detector 163, when a frame detection mode is not set. The frame path selector 162 may be implemented using a switch.

When a frame detection mode for a particular frame type is set, the frame detector 163 detects an image frame of the specified type (for example, an I-frame) in image frames from the frame path selector 162, and sends only the detected image frame to the video decoder 164.

I-frames are reference frames for MPEG compression and decompression, and are repeated in an MPEG-compressed video stream by a preset period of time (0.5 seconds for a satellite DMB system). The size of an I-frame is greater than that of a P-frame or B-frame. For example, the P-frame size is about 1/10 of the I-frame size.

The frame detector 163 may pre-store I-frame periods of corresponding video data to detect an image frame received at each I-frame period as an I-frame, or compare sizes of received image frames to detect a relatively large image frame as an I-frame.

The video decoder 164 decodes video data having whole image frames from the frame path selector 162 or video data of I-frames only from the frame detector 163.

The video output buffer 165 temporarily stores decoded video data from the video decoder 164 for audio/video synchronization.

The display unit 170 may include a panel of liquid crystal display devices and displays decoded video data from the video output buffer 165 under the control of the control unit 180.

The control unit 180 controls the overall operation of the digital broadcast receiver. In particular, the control unit 180 controls the broadcast receiving unit 120 according to a user command input through the input unit 110. The control unit 180 also controls the frame path selector 162 according to frame type information input through the input unit 110.

The control unit 180 extracts information related to data identification, video frame identification and synchronization from a header portion of received digital broadcast data. The data identification information is used to separate received digital broadcast data into audio data and video data. The video frame identification information is used to identify image frames (I-frame, P-frame and B-frame) in video data. The synchronization information is time stamp data for audio/video synchronization. Using the synchronization information, the control unit 180 controls synchronized the output of decoded audio data and video data through the speaker 150 and the display unit 170.

The control unit 180 further controls the frame detector 163 to detect an image frame according to a user selection.

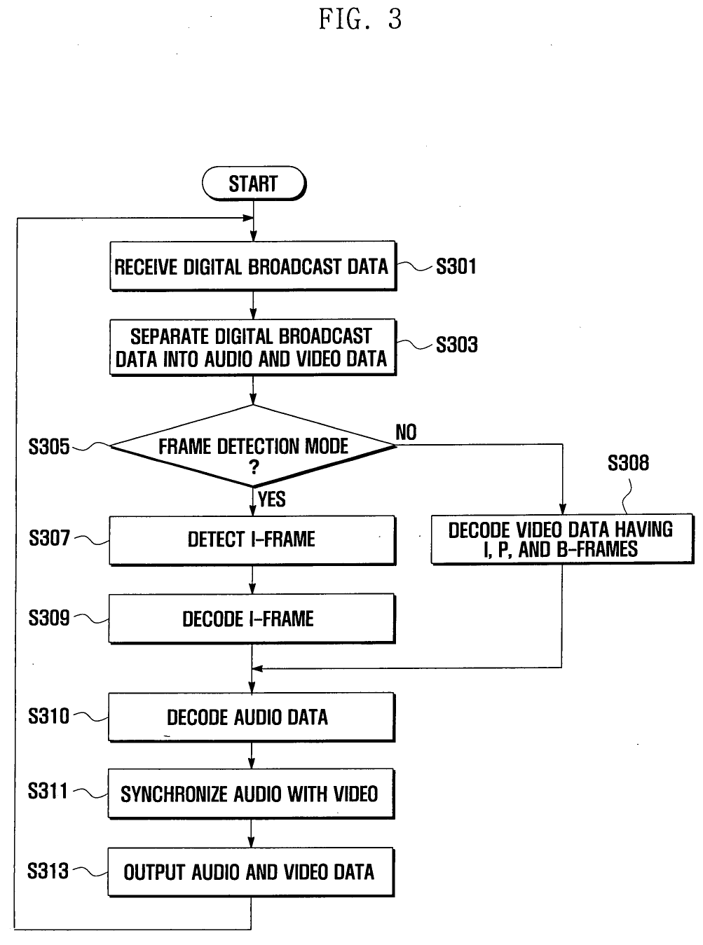

FIG. 3 is a flow chart illustrating a digital broadcast data processing method according to another exemplary embodiment of the present invention.

Referring to FIG. 3, the control unit 180 controls the broadcast receiving unit 120 to receive digital broadcast data corresponding to a selected broadcast channel and deinterleaves the received digital broadcast data (S301).

The control unit 180 controls the data separating unit 130 to separate the digital broadcast data into audio data and video data using data identification information, and send the audio data and the video data to the audio input buffer 141 of the audio decoding unit 140 and to the video input buffer 161 of the video decoding unit 160 (S303).

The control unit 180 checks whether a frame detection mode is set (S305). For the purpose of description, only I-frames are detected in the frame detection mode.

If a frame detection mode is set, the control unit 180 controls the frame path selector 162 to direct the video data stored in the video input buffer 161 to the frame detector 163, which then detects an I-frame in the video data (S307) and sends the detected I-frame to the video decoder 164. The video decoder 164 decodes the I-frame from the frame detector 163 (S309). The control unit 180 stores the decoded I-frame in the video output buffer 165.

The control unit 180 controls the audio decoding unit 140 to decode the audio data stored in the audio input buffer 141 and to store the decoded audio data in the audio output buffer 143 (S310).

The control unit 180 obtains synchronization information, preferably time stamp data, from header portions of the audio data and video data, and synchronizes the decoded audio data in the audio output buffer 143 with the decoded I-frame in the video output buffer 165 (S311).

The control unit 180 outputs the decoded audio data through the speaker 150 and the decoded video data of an I-frame through the display unit 170 in a synchronized manner (S313).

If a frame detection mode is not set at step S305, the control unit 180 controls the frame path selector 162 to direct the video data stored in the video input buffer 161 to the video decoder 164, bypassing the frame detector 163. Subsequent processing steps for the video data having whole image frames are similar to corresponding steps for the video data of an I-frame. That is, the video data having whole image frames is decoded (at step S308), synchronized with the audio data that is decoded at step S310 (at step S311) for subsequent output (at step S313).

As apparent from the above description, the present invention provides a digital broadcast receiver and broadcast data processing method that extract only image frames of a selected type from received digital broadcast data for decoding and output. Decoding image frames of a selected type only can increase the speed of a streaming service, and reduce a processing load on and power consumption of a video decoding unit.

While exemplary embodiments of the present invention have been shown and described in this specification, it will be understood by those skilled in the art that various changes or modifications of the embodiments are possible without departing from the spirit and scope of the invention as defined by the appended claims.

What is claimed is:

1. A broadcast data processing method comprising:
separating digital broadcast data into audio data and video data;
detecting, if a frame detection mode for a particular frame type is set, an image frame of the specified type in the video data to decode the detected image frame and output the decoded video data; and
synchronizing the output video data with the audio data and outputting the synchronized video and audio data.

2. The broadcast data processing method of claim 1, wherein the video data in the separating step comprises I, P, and B-frames.

3. The broadcast data processing method of claim 1, wherein the image frame of the specified type is an I-frame.

4. The broadcast data processing method of claim 1, wherein the synchronizing step comprises:
extracting synchronization information from the audio data to be output; and
finding an image frame of the specified type corresponding to the synchronization information.

5. The broadcast data processing method of claim 1, further comprising outputting, if a frame detection mode is not set, the video data having I, P, and B-frames.

6. A digital broadcast receiver comprising:
a broadcast receiving unit for receiving digital broadcast data;
a data separating unit for separating the received digital broadcast data into audio data and video data;
an input unit for inputting a frame type information from a user to set a frame detection mode;
a video decoding unit for decoding an image frame, in the video data, of a type specified in the frame type information;
a control unit for synchronizing output video data of the decoded image frame with the audio data to be output; and
a display unit for displaying the output video data in a synchronized manner with the audio data to be output.

7. The digital broadcast receiver of claim 6, wherein the video decoding unit comprises:
a frame detector for detecting the image frame of the type specified in the frame type information in the video data having I, P, and B-frames;
a video decoder for decoding the image frame detected by the frame detector or the video data having I, P, and B-frames; and
a frame path selector for directing the video data having I, P, and B-frames to the video decoder or to the frame detector.

8. The digital broadcast receiver of claim 7, wherein the control unit controls the frame detector to detect an image frame of a particular type according to a user selection.

9. The digital broadcast receiver of claim 7, wherein the frame detector detects an I-frame.

10. The digital broadcast receiver of claim 7, wherein the frame path selector comprises a switch for directing the video data to the video decoder or to the frame detector.
